(19) United States
(12) Patent Application Publication
(10) Pub. No.: US 2009/0053420 A1
(43) Pub. Date: Feb. 26, 2009

(54) THERMOSETTING COATING COMPOSITIONS WITH MULTIPLE CURE MECHANISMS

(75) Inventors: SUNITHA GRANDHEE, NOVI, MI (US); SWAMINATHAN RAMESH, CANTON, MI (US)

Correspondence Address: Harness, Dickey and Pierce, P.L.C., 5445 Corporate Drive, Troy, MI, 48098, US

(73) Assignee: BASF CORPORATION, SOUTHFIELD, MI (US)

(21) Appl. No.: 11/841,034

(22) Filed: Aug. 20, 2007

(51) Int. Cl. B05D 3/02; C08F 8/30; C08L 75/04

(52) U.S. Cl. 427/386; 525/374; 525/124

(57) ABSTRACT

A curable coating composition comprising an acrylic polymer having an epoxide equivalent weight from about 150 to about 1500, a compound having acid and carbamate groups, and an aminoplast crosslinker may be applied to a substrate and cured at a temperature at which both acid and carbamate groups of the compound react. The composition may further contain a blocked polyisocyanate crosslinker to react with hydroxyl groups on the polymer and/or formed by reaction of epoxide with carboxylic acid groups.

### FIELD OF THE INVENTION

The invention relates to thermosetting coating compositions, materials therefor, and methods of making and using such coatings compositions.

### BACKGROUND OF THE INVENTION

Curable, or thermosettable, coating compositions are widely used in the coatings art, particularly for topcoats in the automotive and industrial coatings industry. Color-plus-clear composite coatings provide topcoats with exceptional gloss, depth of color, distinctness of image, and special metallic effects. The automotive industry has made extensive use of these coatings for automotive body panels. A topcoat coating should be durable to maintain its appearance and provide protection under service conditions during the lifetime of the coated article. Topcoat coatings for automotive vehicles, for example, are typically exposed to all kinds of weather, ultraviolet rays from the sun, abrasions from gravel thrown up during driving or from items set on the car when parked, and other conditions that can degrade the coating. For some time, researchers have directed their efforts to providing coatings with greater resistance to environmental etch. “Environmental etch” is a term applied to a kind of exposure degradation that is characterized by spots or marks on or in the finish of the coating that often cannot be rubbed out.

Curable coating compositions utilizing carbamate-functional resins are described, for example, in U.S. Pat. Nos. 5,693,724, 5,693,723, 5,639,828, 5,512,639, 5,508,379, 5,451,656, 5,356,669, 5,336,566, and 5,532,061, each of which is incorporated herein by reference. These coating compositions can provide significant improvements in resistance to environmental etch over other coating compositions, such as hydroxy-functional acrylic/melamine coating compositions. On the other hand, carbamate-functional resins tend to require more organic solvent to achieve acceptable viscosity for application and leveling of the applied film to obtain desired smoothness. Coatings with higher amounts of organic solvent produce more regulated emissions during application. Coatings with hydroxyl-functional acrylic polymers cured using blocked polyisocyanate can also provide excellent resistance to environmental etch in cured coatings, but these coatings do not have the desired scratch and mar resistance. Coatings with hydroxyl-functional acrylic polymers cured using aminoplasts can be formulated at higher solids and cured at lower temperatures relative to the other compositions mentioned, but do not provide the environmental etch resistance or scratch and mar resistance of the other coatings. Other coating chemistries have been used, but these also have shortcomings, such as poor weathering properties or high volatile organic content [VOC]. Coatings using the epoxy/acid crosslinking reaction provide good properties, but may have chalking and flaking in longer term weathering.

U.S. Pat. Nos. 5,693,724, 5,693,723, 5,639,828, 5,512,639, 5,508,379, 5,451,656, 5,356,669, 5,336,566, 5,532,061 and 6531560 describe incorporating carbamate functionality by ‘trans-carbamating’ hydroxyl-functional acrylic resins. The reaction step is a time-consuming process, however, and produces side products like methanol that, along with other solvents used for the reaction medium, must be removed somehow. Also, the resulting resin is a higher viscosity solution due to presence of carbamate groups, resulting in lower paint solids and higher VOCs. U.S. Pat. No. 6,391,970 describes a coating that cures by a first reaction between epoxy and carboxylic acid groups, which generates hydroxyl groups, and a second reaction between the hydroxyl groups generated and a polyisocyanate crosslinking agent.

It would be advantageous to have a coating composition that could provide desired environmental etch resistance and improved scratch and mar resistance without dramatically increasing the viscosity of the coating composition.

### SUMMARY OF THE INVENTION

The present invention provides a curable coating composition comprising an acrylic polymer having an epoxide equivalent weight from about 150 to about 1500, a compound having acid and carbamate groups, and an aminoplast crosslinker. This coating composition may be applied to a substrate and cured at a temperature at which both acid and carbamate groups of the compound react. The compound having acid and carbamate groups may have one acid group per 0.5 to 1.5 carbamate groups, on average, but it is preferred that the compound have substantially about the same acid equivalent weight and carbamate equivalent weight. In particular, the compound having acid and carbamate groups may be a reaction product of a cyclic carboxylic acid anhydride compound and an hydroxyalkyl carbamate.

An aminoplast for purposes of the invention is a material obtained by reaction of an activated nitrogen with a lower molecular weight aldehyde forming an alkylol group, optionally further reacted with an alcohol (preferably a mono-alcohol with one to four carbon atoms) to form an ether group.

A carbamate group has a structure

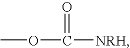

in which R is H or alkyl. Preferably, R is H or alkyl of from 1 to about 4 carbon atoms, and more preferably R is H.

The invention also provides an embodiment in which the acrylic polymer also has an hydroxyl equivalent weight of from about 300 to about 700.

The invention also provides an embodiment in which the coating composition further comprises a second acrylic polymer, the second acrylic polymer having an hydroxyl equivalent weight of from about 300 to about 700.

The invention also provides an embodiment in which the coating composition further comprises a blocked polyisocyanate curing agent.

The invention also provides an embodiment in which the coating composition comprises a further material that has carboxylic acid, carbamate, epoxide, or hydroxyl groups.

The invention also provides a method of coating a substrate including steps of applying a coating composition of the invention and curing the applied layer of coating composition. In particular, the curing temperature may be selected to allow reaction of both the acid and carbamate groups of the compound having acid and carbamate groups.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### DETAILED DESCRIPTION OF THE PREFERRED EMBODIMENTS

The following description of the preferred embodiment(s) is merely exemplary in nature and is in no way intended to limit the invention, its application, or uses.

The curable coating composition includes an acrylic polymer having an epoxide equivalent weight from about 150 to about 1500, a compound having acid and carbamate groups, and an aminoplast crosslinker. The invention also provides an embodiment in which the acrylic polymer also has an hydroxyl equivalent weight of from about 300 to about 700. The curable coating composition may also have hydroxyl functionality on the same acrylic polymer with epoxide functionality, or on a second acrylic polymer. The curable coating composition may further include a blocked polyisocyanate curing agent, other resins, polymers or compounds with carboxylic acid groups, epoxide groups, carbamate groups, or hydroxyl groups, as well as other usual coatings materials, such as pigments, solvents, catalysts, and other additives.

The acrylic polymer with epoxide equivalent weight from about 150 to about 1500 may be produced by copolymerizing an appropriate amount of a glycidyl-group monomer(s), for example by copolymerizing one or more of the monomers glycidyl acrylate, glycidyl methacrylate, or allyl glycidyl ether.

The acrylic polymer with epoxide equivalent weight from about 150 to about 1500 may also have hydroxyl groups. Hydroxyl groups may conveniently be incorporated by copolymerizing an hydroxyl-functional monomer, for example hydroxyethyl acrylate, hydroxyethyl methacrylate, hydroxypropyl acrylate, hydroxypropyl methacrylate, hydroxybutyl acrylate, hydroxybutyl methacrylate, and so on, or combinations of such monomers, in the polymer synthesis.

In addition to or instead of including hydroxyl functionality on the acrylic polymer with epoxide equivalent weight from about 150 to about 1500, the clearcoat composition may optionally further include a second acrylic copolymer having hydroxyl functionality. The second acrylic polymer with hydroxyl groups may conveniently be obtained by polymerizing one of the hydroxyl functional monomers already mentioned.

The hydroxyl equivalent weight of the acrylic polymer with epoxide groups, if made with hydroxyl monomer(s), or of the second acrylic polymer, if included, is preferably from about 300 to about 700.

The acrylic polymers may be polymerized using one or more further comonomers. Examples of such comonomers include, without limitation, esters of α,β-ethylenically unsaturated monocarboxylic acids containing 3 to 5 carbon atoms such as acrylic, methacrylic, and crotonic acids and of α,β-ethylenically unsaturated dicarboxylic acids containing 4 to 6 carbon atoms; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates. Representative examples of other ethylenically unsaturated polymerizable monomers include, without limitation, such compounds as dialkyl fumaric, maleic, and itaconic esters, prepared with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, .alpha.-methyl styrene, vinyl toluene, tert-butyl styrene, and 2-vinyl pyrrolidone. The comonomers may be used in any combination.

The acrylic polymers may be prepared using conventional techniques, such as by heating the monomers in the presence of a polymerization initiating agent and optionally chain transfer agents. The polymerization is preferably carried out in solution, although it is also possible to polymerize the acrylic polymer in bulk. Suitable polymerization solvents include, without limitation, esters, ketones, ethylene glycol monoalkyl ethers and propylene glycol monoalkyl ethers, alcohols, and aromatic hydrocarbons.

Typical initiators are organic peroxides such as dialkyl peroxides such as di-t-butyl peroxide, peroxyesters such as t-butyl peroctoate and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol, and dimeric alpha-methyl styrene.

The solvent or solvent mixture is generally heated to the reaction temperature and the monomers and initiator(s) and optionally chain transfer agent(s) are added at a controlled rate over a period of time, typically from about two to about six hours. The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes, more preferably no more than about five minutes. Additional solvent may be added concurrently. The mixture is usually held at the reaction temperature after the additions are completed for a period of time to complete the polymerization. Optionally, additional initiator may be added to ensure complete conversion of monomers to polymer.

The acrylic polymers should have a weight average molecular weight of at least about 2400, preferably at least about 3000, more preferably at least about 3500, and particularly preferably at least about 4000. Weight average molecular weight may be determined by gel permeation chromatography using polystyrene standard. In addition, the weight average molecular weight is preferably up to about 7000, more preferably up to about 5000, and still more preferably up to about 4500.

The clearcoat coating composition preferably includes from about 50% to about 85%, more preferably from about 60% to about 75% by weight of the first vinyl polymer having epoxide functionality, based on the vehicle weight. The “vehicle weight” is the total weight of the thermoset, film-forming components in the coating composition. The clearcoat coating composition preferably includes from about 5% to about 40%, more preferably from about 15% to about 30% by weight of the second vinyl polymer having hydroxyl functionality, based on the vehicle weight.

The coating composition also includes a compound having acid and carbamate groups. The compound having acid and carbamate groups may have one acid group per 0.5 to 1.5 carbamate groups, on average, but it is preferred that the compound have substantially about the same acid equivalent weight and carbamate equivalent weight. The compound preferably is the monomeric and has a molecular weight of from about 191 to about 471. The compound may preferably have from about 6 to about 25 carbons, at least one carboxylic acid group and at least one carbamate group.

In particular, the compound having acid and carbamate groups may be a reaction product of a cyclic carboxylic acid anhydride compound and an hydroxyalkyl carbamate. Examples of suitable anhydrides compounds include, without limitation, phthalic anhydride, tetrahydrophthalic anhydride, succinic anhydride, glutaric anhydride, maleic anhydride, trimellitic anhydride, pyromellitic anhydride, hexahydrophthalic anhydride, and methylhexahydrophthalic anhydride. Examples of suitable hydroxyalkyl carbamate compounds include, without limitation, hydroxymethyl carbamate, hydroxyethyl carbamate, hydroxypropyl carbamate, hydroxybutyl carbamate, C-36 dimer alcohol monocarbamate, diethyloctane diol monocarbamate (DEOD monocarbamate), and the reaction product of the carbamate of glydicyl neodecanote. An anhydride may be reacted with a hydroxyl carbamate until all of the anhydride groups have been reacted. The reaction is usually carried out at temperatures of 100 to 140° C., and the end of the reaction may be monitored by infrared spectroscopy or by titrating for acid groups after hydroxylizing any remaining anhydride.

The coating composition also includes an aminoplast as a crosslinker. An aminoplast for purposes of the invention is a material obtained by reaction of an activated nitrogen with a lower molecular weight aldehyde, optionally further reacted with an alcohol (preferably a mono-alcohol with one to four carbon atoms) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups.

The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred The etherification may be carried out, for example, by the processes disclosed in U.S. Pat. Nos. 4,105,708 and 4,293,692, the disclosures of which are incorporated herein by reference.

It is preferred for the aminoplast to be at least partially etherified, and especially preferred for the aminoplast to be fully etherified. The preferred compounds have a plurality of methylol and/or etherified methylol groups, which may be present in any combination and along with unsubstituted nitrogen hydrogens. Fully etherified melamine-formaldehyde resins are particularly preferred, for example and without limitation hexamethoxymethyl melamine.

The curable coating composition may further include a blocked polyisocyanate curing agent. Blocked polyisocyanate crosslinkers include, without limitation, blocked isocyanurates, blocked biurets, blocked allophanates, uretdione compounds, and blocked isocyanate-functional prepolymers such as the reaction product of one mole of a triol with three moles of a diisocyanate.

The amount of isocyanate is preferably chosen as to react with all the hydroxy groups, both hydroxyl groups from the hydroxy acrylic resin and the hydroxy groups that will be formed due to reaction of carboxylic acid with epoxide. The amount of isocyanate may also be lower so as to allow for some free hydroxyl to be present at the end of cure to aid in repair adhesion in case of a film defect. U.S. Pat. No. 6,391,970 teaches the ratios of epoxide to acid to isocyanates for desired film properties.

The coating composition may include one or more further components with carboxylic acids, carbamate, epoxide, or hydroxyl groups. Examples of such further components include, without limitation, neodecanoic acid, glycidyl ester of neodecanoic acid, hydroxystearic acid, fatty acids having 8 to 18 carbon atoms, dimer fatty acids, trimer fatty acids, fatty alcohols having 8 to 18 carbon atoms, dimer fatty alcohols, trimer fatty alcohols, and combinations of these, which may be added to impart flexibility to the coating, if desired.

Pigments and fillers may be utilized in amounts typically of up to about 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like.

The coating composition may include a catalyst to enhance the cure reaction. Such catalysts are well-known in the art and include, without limitation, zinc salts, tin salts, blocked para-toluenesulfonic acid, blocked dinonylnaphthalenesulfonic acid, or phenyl acid phosphate. Also, tin compounds as dibutyl tin dilaurate, dibutyl tin oxide can be added to promote the hydroxy-isocyanate reaction.

A solvent or solvents may be included in the coating composition. In general, the solvent can be any organic solvent and/or water. In one preferred embodiment, the solvent includes a polar organic solvent. More preferably, the solvent includes one or more organic solvents selected from polar aliphatic solvents or polar aromatic solvents. Still more preferably, the solvent includes a ketone, ester, acetate, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents. In general, protic solvents such as alcohol and glycol ethers are avoided when the coating composition includes the optional polyisocyanate crosslinker, although small amounts of protic solvents can be used even though it may be expected that some reaction with the isocyanate groups may take place during curing of the coating.

Additional agents, for example hindered amine light stabilizers, ultraviolet light absorbers, anti-oxidants, surfactants, stabilizers, wetting agents, rheology control agents, dispersing agents, adhesion promoters, etc. may be incorporated into the coating composition. Such additives are well-known and may be included in amounts typically used for coating compositions.

The coating compositions can be coated on a substrate by spray coating. Electrostatic spraying is a preferred method. The coating composition can be applied in one or more passes to provide a film thickness after cure of typically from about 20 to about 100 microns.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

After application of the coating composition to the substrate, the coating is cured, preferably by heating at a temperature and for a length of time sufficient to cause the reactants to form an insoluble polymeric network. The cure temperature is usually from about 105° C. to about 175° C., and the length of cure is usually about 15 minutes to about 60 minutes. Preferably, the coating is cured at about 120° C. to about 150° C. for about 20 to about 30 minutes. Heating can be done in infrared and/or convection ovens.

In one embodiment, the coating composition is utilized as the clearcoat of an automotive composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups. Preferred crosslinkable functional groups include hydroxy functional groups and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The clearcoat coating composition of this invention is generally applied wet-on-wet over a basecoat coating composition as is widely done in the industry. The coating compositions described herein are preferably subjected to conditions so as to cure the coating layers as described above.

The invention is further described in the following examples. The examples are merely illustrative and do not in any way limit the scope of the invention as described and claimed. All parts are parts by weight unless otherwise noted.

### Preparation 1: Synthesis of Epoxy-Functional Acrylic Resin.

400 g of Aromatic 100 were heated to 150° C. in a round bottom flask, and a mixture of 1600 g glycidyl methacrylate, 40 g glycyl methacrylate carbonate, 160 g n-butyl acrylate, 200 g methyl methacrylate, and 100 g aromatic 100 were added in three hours at a uniform rate simultaneously with a mixture of 200 g t-butyl-peroxy-2-ethylhexanoate and 100 g. aromatic 100. After all the mixture was added, a further 20 g of TBPO and 30 g of Aromatic 100 were added to the reaction mixture over 30 minutes at a constant rate to convert any unreacted monomers. The contents of the flask were maintained at the reaction temperature for an additional hour and then cooled. The acrylic polymer product had a 70% non-volatiles content and a titrated weight per epoxide (WPE) of 180 g/epoxide. The polymer had a molecular weight Mₙ of 2120, M_{w} of 3670, polydispersity of 1.7 against a polystyrene standard and a calculated (using the Fox equation) T_{g} of 64° C.

### Preparation 2: Synthesis of Epoxy-Functional Acrylic Resin.

60 g of Aromatic 100 were heated to 140° C. in a reaction vessel, and a mixture of 99.4 g glycidyl methacrylate, 40.6 g n-butyl acrylate, 60 g butyl methacrylate, and 10 g. aromatic 100 were added at a constant rate over four hours simultaneously with 20 g tert-butyl-peroxy-2-ethylhexanoate in 10 g aromatic 100. After all the mixture was added, 2 g of tert-butyl-peroxy-2-ethylhexanoate in 10 g aromatic 100 were added to the reaction mixture over thirty minutes at a constant rate to convert any unreacted monomers. The contents of the flask were maintained at 140° C. for an additional 1 hour and then cooled. The acrylic polymer product had a 70% non-volatiles content and a titrated weight per epoxide (WPE) of 300 g per epoxide group. The polymer had a molecular weight Mₙ of 745, M_{w} of 1400, and polydispersity of 1.9 measured by GPC against a polystyrene standard. The resin had a calculated (using the Fox equation) T_{g} of 23° C.

### Preparation 3: Synthesis of Acid, Carbamate Compound.

308 g of hexahydrophthalic anhydride, 238 g of hydroxypropyl carbamate, and 103 g of n-butyl acetate were heated to and maintained at 100-110° C. for about twelve hours until IR showed the complete absence of anhydride peaks 1850 and 1780 cm⁻¹ and titration with aqueous sodium hydroxide showed the acid equivalence to be between 260 and 273 g/COOH. The final product was found to be at 77.6% by weight non-volatile and was a waxy solid with acid equivalent weight of 274.9 g/COOH.

### Preparation 4: Synthesis of Acid Carbamate Compound.

200 g of succinic anhydride, 119 g of hydroxypropyl carbamate, and 100 g of toluene were held at 100-110° C. in a reaction vessel. The reaction was followed by infrared spectroscopy (IR) (disappearance of anhydride peaks at 1850 and 1780 cm⁻¹) as well as by titration with aqueous sodium hydroxide. When IR showed no peaks at 1850 and 1780 cm⁻¹ and the titration showed that the equivalence of acid was between 210-230 g/COOH, the reaction was stopped. The final product was at 81% by weight non-volatiles and had an equivalent weight of 213 g/COOH.

### Preparation 5: Synthesis of a Hydroxy-Containing Acrylic Polymer

A mixture of 12.4 g acrylic acid, 48.2 g of 2-hydroxyethyl methacrylate, 16.6 g of 2-ethylhexyl acrylate, 8 g of styrene, 42 g of n-butyl methacrylate, and 7.4 g of methyl methacrylate was added evenly over four hours simultaneously with a solution of 12.4 g of tert-butyl peroxy 2-ethylhexanoate and 6 g of tert-butyl peroxy acetate in 2 g of propylene glycol monopropyl ether to a reactor containing 25 g of propylene glycol monopropyl ether at 150° C. After the addition, the product was maintained at 140° C. for an additional hour to complete the conversion. 30 g of methyl propyl ketone were added to bring the resin to a 65% nonvolatile solution. Theoretical Tg was calculated to be 23.4° C., measured equivalent weight was 330 g/hydroxyl, and a GPC analysis against a polystyrene standard showed molecular weight of Mn 3300, Mw 5850 and polydispersity 1.8.

### EXAMPLES 1-7

### Coating Compositions

| | EXAMPLES,g | | | | | | |
|---|---|---|---|---|---|---|---|
| INGREDIANT | 1 | 2 | 3 | 4 | 5 | 6 | 7 |
| Prep 1 | | | | | | | 27.2 |
| Prep 2 | | 8.0 | 20.0 | 60.0 | 100.0 | 100.0 | |
| Prep 3 | | 6.5 | 16.0 | 49.5 | 80.0 | | 34.7 |
| Prep 4 | | | | | | 62.0 | |
| Prep 5 | 100.0 | 90.0 | 75.0 | 25.0 | | | |
| Neodecanoic | | | | | | | 8.8 |
| acid | | | | | | | |
| Resimene BM- | 10.0 | 9.0 | 7.5 | 2.5 | | | 3.1 |
| 9539¹ | | | | | | | |
| HDI:DMP | 10.0 | 9.0 | 7.5 | 2.5 | | | |
| blocked² | | | | | | | |
| Cymel 327³ | 14.0 | 13.6 | 15.0 | 18.0 | 32.0 | 32.0 | 12.8 |
| Additives | 17.2 | 15.5 | 12.9 | 4.3 | 15.5 | 15.5 | 15.5 |
| package⁴ | | | | | | | |
| Exxate 1000 | 1.2 | 1.1 | 0.9 | 0.3 | 1.0 | 1.0 | 1.0 |
| Methyl, propyl | 1.3 | 1.2 | 1.0 | 0.4 | 1.0 | 1.0 | 1.0 |
| ketone | | | | | | | |
| TOTAL, g | 153.7 | 153.9 | 155.8 | 162.5 | 229.5 | 211.5 | 104.1 |

¹Resimene BM-9539 is available from UCB Surface Specialties
²HDI:DMP = dimethylpyrazole blocked hexamethylene diisocyanate
³CYMEL 327 is available from Cytec Industries.
⁴The additives package included light stabilizers, rheology control agents, a strong acid catatyst, leveling agents, and solvent.

The coating compositions used the following combinations:

| | Hydroxy acrylic resin + | Epoxy resin + acid |
|---|---|---|
| Formulation | cross-linker % | carbamate + crosslinker % |
| 1 | 100 | |
| 2 | 90 | 10 |
| 3 | 75 | 25 |
| 4 | 50 | 50 |
| 5, 6 & 7 | | 100 |

The coating compositions of Examples 1 to 7 were tested in the following ways. The nonvolatile content was measured. The coating composition examples were sprayed over steel panels coated with an electrodeposition primer, 1 ml (25.4 mm) of a spray primer (U28 primer supplied by BASF), and 0.6 mil of waterborne black basecoat E54 KW225 (supplied by BASF) and baked for 20 minutes at 285° F. (140° C.). The cured coating film was about 1.8 mils (45.7 mm) thick. The extent of cure was measured by methyl, ethyl ketone double rubs according to ASTM method D5402. The hardness of the cured coating was measured as Fisher hardness according to DIN 50359, using a Fisherscope hardness tester model HM100V set for a maximum force of 100 mN ramped in series of 50, 1 second steps. Hardness was recorded in N/mm. Tukon hardness was measured according to ASTM method D1474 and is reported in Knoop units. A Crockmeter was used to test the scratch and mar resistance of the cured coatings before and after 10 cycles testing and the gloss was measured with a HunterPro gloss meter, according to ASTM method D523. The testing results are set out in the following table.

| | | MEK | | | |
|---|---|---|---|---|---|
| | % NV | double | Fisher | Tucon | Crockmeter |
| Example | (spray) | rubs | hardness | Hardness | Gloss retention |
| 1 | 60 | 100 | 86 | 10.2 | 81.2% |
| 2 | 60.5 | >200 | 92.6 | 10.3 | 86.5% |
| 3 | 60.2 | >200 | 102.6 | 10.8 | 85.8% |
| 4 | 60.4 | >200 | 127.5 | 16.1 | 86.3% |
| 5 | 61 | >200 | 140.3 | 14.2 | 43.5% |
| 6 | 62.2 | >200 | 131.7 | 12.2 | 94% |
| 7 | 62.0 | >200 | 194 | 11.2 | Not done |

w

The results show that the paint formulations containing the materials which can undergo ‘cascading cross-links’ show equal or better film properties as measured by MEK double rubs, Fisher and Tukon hardness and non-volatiles (and hence lower VOC numbers).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A curable coating composition, comprising:
(a) an acrylic polymer having an epoxide equivalent weight from about 150 to about 1500;
(b) a reaction product of a cyclic carboxylic acid anhydride compound and an hydroxyalkyl carbamate; and
(c) an aminoplast crosslinker.

2. A curable coating composition according to claim 1, wherein the anhydride compound is a monofunctional anhydride compound.

3. A curable coating composition according to claim 1, wherein the anhydride compound is a polyfunctional anhydride compound.

4. A curable coating composition according to claim 1, wherein the anhydride compound is selected from the group consisting of phthalic anhydride, tetrahydrophthalic anhydride, succinic anhydride, maleic anhydride, trimellitic anhydride, pyromellitic anhydride, hexahydrophthalic anhydride, dodecenylsuccinic anhydride, and adipic anhydride.

5. A curable coating composition according to claim 1, wherein the hydroxyalkyl carbamate is selected from the group consisting of hydroxyethyl carbamate, hydroxypropyl carbamate, and hydroxybutyl carbamate.

6. A curable coating composition according to claim 1, further comprising a blocked polyisocyanate crosslinker.

7. A curable coating composition according to claim 1, wherein the acrylic polymer further comprises hydroxyl functionality.

8. A curable coating composition according to claim 7, wherein the acrylic polymer has an hydroxyl equivalent weight of from about 300 to about 700.

9. A curable coating composition according to claim 1, further comprising a second acrylic polymer having an hydroxyl equivalent weight of from about 300 to about 700.

10. A curable coating composition according to claim 1, further comprising a blocked polyisocyanate curing agent.

11. A curable coating composition according to claim 1, further comprising a member selected from the group consisting of neodecanoic acid, glycidyl ester of neodecanoic acid, hydroxystearic acid, fatty acids having 8 to 18 carbon atoms, dimer fatty acids, trimer fatty acids, fatty alcohols having 8 to 18 carbon atoms, dimer fatty alcohols, trimer fatty alcohols, and combinations thereof.

12. A method of coating a substrate, comprising steps of:
(a) applying to the substrate a layer of a curable coating composition comprising an acrylic polymer having an epoxide equivalent weight from about 150 to about 1500, a compound having both acid and carbamate groups, and an aminoplast crosslinker;
(b) curing the applied layer of coating composition at a temperature at which both the acid and carbamate groups of the compound react.

13. A method of coating a substrate according to claim 12, wherein the curable coating composition further comprises a blocked polyisocyanate crosslinker.

14. A method of coating a substrate according to claim 12, wherein the acrylic polymer further comprises hydroxyl functionality.

15. A method of coating a substrate according to claim 14, wherein the acrylic polymer has an hydroxyl equivalent weight of from about 300 to about 700.

16. A method of coating a substrate according to claim 12, wherein the curable coating composition further comprises a second acrylic polymer having an hydroxyl equivalent weight of from about 300 to about 700.

17. A method of coating a substrate according to claim 12, wherein the compound having both acid and carbamate groups has, on average, one acid group per 0.5 to 1.5 carbamate groups.

18. A method of coating a substrate according to claim 12, wherein the compound having both acid and carbamate groups is a reaction product of an anhydride compound and an hydroxyalkyl carbamate.

19. A method of coating a substrate according to claim 18, wherein the anhydride compound is selected from the group consisting of phthalic anhydride, tetrahydrophthalic anhydride, succinic anhydride, maleic anhydride, trimellitic anhydride, pyromellitic anhydride, and hexahydrophthalic anhydride, and further wherein the hydroxyalkyl carbamate is selected from the group consisting of hydroxyethyl carbamate, hydroxypropyl carbamate, and hydroxybutyl carbamate.
